(19) United States
(12) Patent Application Publication
(10) Pub. No.: US 2004/0193353 A1
(43) Pub. Date: Sep. 30, 2004

(54) Adaptive cruise control apparatus

(76) Inventors: Alain Dunoyer, Coventry (GB); Adam Leatherland, Coventry (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/758,834

(22) Filed: Jan. 16, 2004

(30) Foreign Application Priority Data
Jan. 16, 2003 (GB) 0300974.3

(51) Int. Cl. B60K 31/00

(52) U.S. Cl. 701/96; 701/301; 180/170

(57) ABSTRACT

An adaptive cruise control module (1) for automatically bringing a vehicle to a halt behind a target vehicle includes a look-up table (8) holding pre-computed brake demand values for given target ranges and vehicle speeds. A controller (7) applies an appropriately selected brake demand value to the vehicle's braking system (4) until the vehicle comes to rest. The look-up table (8) values are computed such that the rate of deceleration and rate of change of deceleration closely match those applied by a typical driver when manually stopping a vehicle. A further refinement allows the vehicle to creep along behind the target vehicle in a slowly-moving queue of traffic by providing the look-up table (8) with throttle demand values for given target ranges for application to a throttle control system (5, 6).

The present invention relates to adaptive cruise control for motor vehicles.

Conventional cruise control systems fulfil the function of speed control of the vehicle. A desired speed is set by the driver and a control system operates on the engine (usually the throttle only) to maintain the desired speed. When the traffic is light, this simple speed control is acceptable to the driver, however if the traffic is heavy the driver is faced with constantly adjusting the set speed in order to maintain a safe distance from preceding traffic and may have to disengage the cruise control in order to brake.

Many systems have now been developed by the addition of a distance sensor to the conventional cruise control system which adds distance keeping to the basic speed control function. Many such systems also include means to monitor the relative velocities of the vehicle which is equipped with the cruise control system and a preceding vehicle. Moreover the engine control also often includes a limited authority braking system, so that the speed control/distance keeping can be effected by a combination of the throttle and the brake.

Such a system may operate as an adaptive cruise control system which, when activated, enables the vehicle in question to reduce speed automatically when a preceding target vehicle is detected in its path. The vehicle will then follow, no closer than a minimum set time gap (equivalent to a minimum distance), the closest preceding target vehicle that is “in path.” This will continue until the closest preceding target vehicle is detected to move out of the path of the vehicle at which point the original set speed is resumed. An example of this type of system is disclosed in patent document U.S. Pat. No. 5,710,565.

Hence an adaptive cruise control system is one that maintains cruise speed i n the same way as a conventional cruise control system when the road ahead is clear but when following a vehicle, maintains the gap to the vehicle ahead by operating the throttle and brake systems. The gap is usually expressed in terms of time headway, for example one second. However, the time headway concept is only valid in steady state conditions, so, when trying to automatically stop behind a target vehicle which comes to a halt in a traffic queue, a different strategy is required.

According to a first aspect of the present invention there is provided adaptive cruise control apparatus for controlling the distance of a vehicle from a target, the vehicle being equipped with a target range measuring device, a vehicle speed measuring device, a braking system and a throttle controller, characterised in that the adaptive cruise control apparatus includes a look-up table containing pre-computed brake demand values for given target ranges and vehicle speeds, and a controller for receiving target range and vehicle speed values from the target range measuring device and vehicle speed measuring device respectively, and being adapted to select, from the look-up table, a brake demand value relating to the received target range and vehicle speed values, for application to the braking system.

According to a second aspect of the present invention, there is provided a method for controlling the distance of a vehicle from a target, the vehicle being equipped with a target range measuring device, a vehicle speed measuring device, a braking system and a throttle controller, characterised in that the method includes the steps of;

receiving a target range value from the target range measuring device,

receiving a vehicle speed value from the vehicle speed measuring device,

selecting from a look-up table containing pre computed brake demand values for given target ranges and vehicle speeds, a brake demand value relating to the received target range and vehicle speed values,

and applying the selected brake demand value to the braking system.

The invention permits an adaptive cruise control vehicle to be brought to a standstill behind a preceding target vehicle.

The inventors have discovered that automatically stopping a vehicle in accordance with Newton's equations of motion i.e. substantially linearly, by applying a constant deceleration rate, feels unnatural to the driver. Most drivers, when manually bringing a vehicle to halt behind a preceding one, tend to decelerate initially at a comparatively high rate until they are within around twelve metres from the vehicle in front and then decelerate more gradually until the vehicle comes to rest a metre or two behind the preceding vehicle. The use of a look-up table enables emulation of this driver behaviour. Thus the invention is able to deliver a consistent and smooth way of stopping behind a preceding vehicle.

The invention has the further advantage of eliminating hunting which can occur when operating the conventional adaptive cruise control system under such conditions.

The look-up table may be compiled empirically.

The present invention further provides a vehicle equipped with adaptive cruise control apparatus in accordance with said first aspect.

In a preferred embodiment, the controller acts to decelerate the vehicle in a linear fashion until the target range is approximately 12 metres, vehicle speed is less than around four metres per second and the vehicle is closing in on the target. Subsequently, the controller decelerates the vehicle in a non-linear fashion.

Optionally, the look-up table may be configured to include vehicle speed demand values relating to measured target range. In this case when braking is no longer required and the vehicle is creeping along behind the target in a queue of vehicles, the controller is further adapted to select from the look up table a vehicle speed demand appropriate to the measured target range, for applying to the throttle controller.

A further optional refinement to this creep mode of operation, comprises a state machine implemented in the controller that forces vehicle speed demand to zero when the brake demand value selected by the controller is non-zero. As braking effect takes a finite time to ramp down to zero, this refinement ensures that the vehicle is not being asked to accelerate whilst at the same time, still braking. As a safety feature, priority is given to braking. One situation i n which this refinement is useful is when the target pulls away whilst the equipped vehicle is still braking to a standstill behind. The state machine waits for the brakes to be fully off before applying the speed demand to the throttle controller.

Some embodiments of the invention will now be described, by way of example only, with reference to the drawings of which;

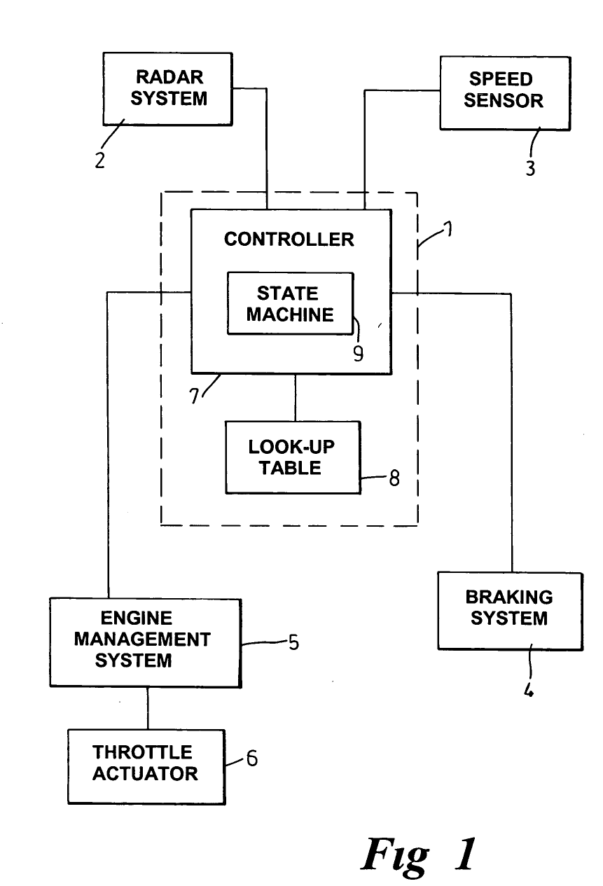

FIG. 1 is a block diagram showing an adaptive cruise control apparatus in accordance with an embodiment of the invention and its incorporation with conventional vehicle systems,

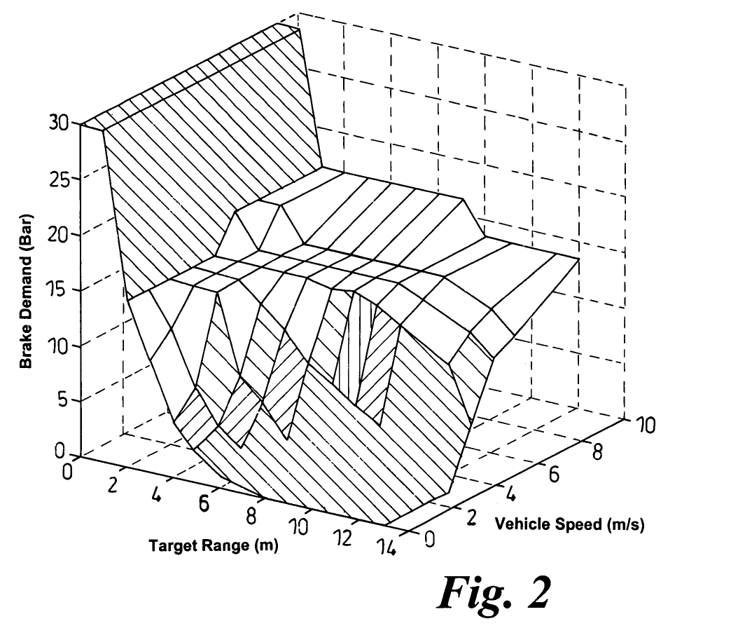

FIG. 2 is a look-up table braking map in accordance with an embodiment of the invention, and

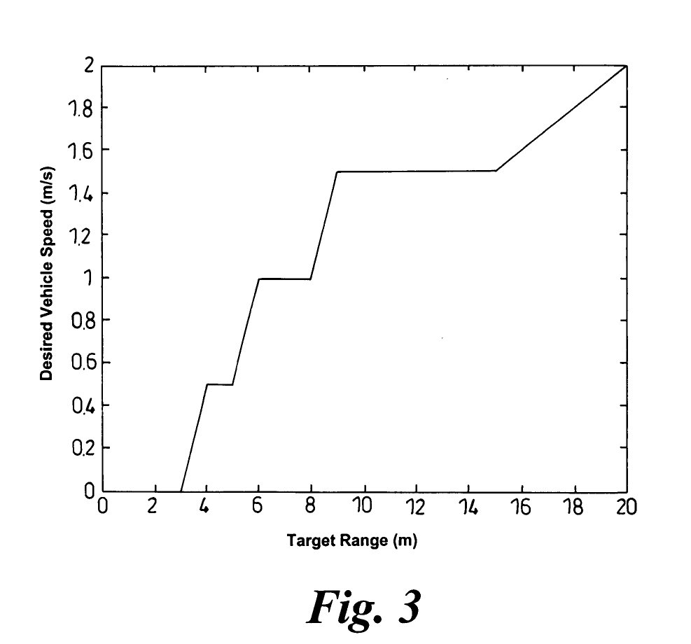

FIG. 3 is a look-up table speed map in accordance with an embodiment of the invention.

In FIG. 1 an adaptive cruise control apparatus (1) is fitted to a vehicle (not shown). The vehicle is also equipped with a radar sensor (2) for measuring the distance between the vehicle so-equipped and a preceding target vehicle (not shown) and also relative vehicle speed, a speed sensor (3) for measuring the speed of the equipped vehicle, a braking system (4), an engine management system (5) and a throttle actuator (6). All the equipment represented in FIG. 1, with the exception of the apparatus (1), operates in a conventional manner.

The adaptive cruise control apparatus (1) comprises a controller (7) and a look u p table (8). The controller (7) has connections to all the other modules of FIG. 1 enabling it to receive and monitor target range values and equipped vehicle speed values, access the look up table (8) and send brake demand and throttle demand signals to the brake system (4) and engine management system (5) respectively.

A portion of the look-up table (8) has a two-dimensional construction which gives brake demand values as a function of preceding target vehicle range and equipped vehicle speed. In this example, the map associated with this first part is shown in FIG. 2. Another portion of the look-up table (8) has a one-dimensional construction which provides a desired equipped vehicle speed value as a function of target range. In this example, the map associated with this second part is shown in FIG. 3.

In operation, initially the equipped vehicle is functioning in adaptive cruise control mode and following a preceding target vehicle at a fixed distance, say 25 meters, in accordance with a set time headway. Suppose that the target vehicle needs to slow down and stop behind a queue of vehicles. As the target begins to slow, its decreasing range to the equipped vehicle is detected by the controller (7) via the radar system (2). Knowing the target range and the speed of the equipped vehicle, the controller (7) uses a conventional proportional derivative algorithm to generate the appropriate brake demand signal which is fed to the braking system (4). The brake demand signal generated at this point in time decelerates the equipped vehicle in a linear fashion down to range of twelve metres and a speed of four metres per second. When these two range and speed conditions are met and the controller (7) detects via the radar system (2), that the vehicle is closing in on the target, then the apparatus (1) enters a mode of operation whereby brake demand is dictated by the look-up table map of FIG. 2, that is the controller (7) monitors target distance (via the radar sensor (2)) and the speed of the equipped vehicle via the speed sensor (3) interrogates the look up table (FIG. 2) to extract the brake demand value relating to the distance and speed values and the generates the appropriate demand signal and applies this signal to the braking system (4). It performs this routine every 100 millisecond in this example until the equipped vehicle comes to standstill.

Once stopped, (either automatically or by the drivers action), the controller (7) then acts to permit the equipped vehicle to move along slowly (in “creep mode”) following behind the target vehicle as the target vehicle moves forwards in a traffic queue. The controller (7) continues to monitor target range but now interrogates the one dimensional part of the look up table (8) for a desired vehicle speed value for the measured target range (FIG. 3). The controller (7) then generates a speed demand signal which it sends to the engine management system (5) which, in turn, send an appropriate throttle demand control signal to the throttle actuator (6). A state machine (9) incorporated in the controller (7) forces the speed demand signal to zero whenever the braking map output (FIG. 2) of the lookup table is non-zero.

1. Adaptive cruise control apparatus (1) for controlling distance of a vehicle from a target, the vehicle being equipped with a target range measuring device (2), a vehicle speed measuring device (3), a braking system (4) and a throttle controller(6), characterised in that the apparatus (1) includes, a look-up table (8) containing pre computed brake demand values for given target ranges and vehicle speeds, and a controller (7)for receiving target range and vehicle speed values from the target range measuring device (2) and the vehicle speed measuring device (3) respectively, and being adapted to select, from the look-up table (8), a brake demand value relating to the received target range and vehicle speed values for application to the braking system (4).

2. Apparatus as claimed in claim 1 in which the look up table (8) further contains pre-computed vehicle speed demand values for given target ranges and in which the controller (7) is further adapted to select from the look-up table (8) a vehicle speed demand value for application to the throttle controller (6).

3. Apparatus as claimed in claim 2 in which the controller (7) incorporates a state machine (9) for forcing the selected vehicle speed demand value to zero when a selected brake demand is non-zero.

4. A vehicle incorporating the adaptive cruise control apparatus (1) of any preceding claim.

5. A method for controlling the distance of a vehicle from a target, the vehicle being equipped with a target range measuring device (2), a vehicle speed measuring device (3), a braking system (4) and a throttle controller (6), characterised in that the method includes the steps of;
receiving a target range value from the target range measuring device (2),
receiving a vehicle speed value from the vehicle speed measuring device (3),
selecting from a look-up table (8) containing pre computed brake demand values for given target ranges and vehicle speeds, a brake demand value relating to the received target range and vehicle speed values,
and applying the selected brake demand value to the braking system (4).

6. A method as claimed in claim 5 including the further step of selecting a pre-computed vehicle speed demand value from a look-up table (8) containing vehicle speed demand values for given target ranges,
and applying the selected vehicle speed demand value to the throttle controller (6).

7. A method as claimed in claim 6 including the further step of forcing the selected vehicle speed demand value to zero when a selected brake demand value is non-zero.
